(19) United States
(12) Patent Application Publication
(10) Pub. No.: US 2011/0063174 A1
(43) Pub. Date: Mar. 17, 2011

(54) PATCH ANTENNA AND WIRELESS COMMUNICATIONS MODULE

(75) Inventors: Yun Hee CHO, Hwaseong (KR); Jong Myeon LEE, Gwacheon (KR); Je Hong SUNG, Hwaseong (KR)

(73) Assignee: SAMSUNG ELECTRO-MECHANICS CO., LTD., Suwon (KR)

(21) Appl. No.: 12/647,610

(22) Filed: Dec. 28, 2009

(30) Foreign Application Priority Data
Sep. 11, 2009 (KR) 10-2009-0086099

(51) Int. Cl. H01Q 1/38; H01Q 1/24

(52) U.S. Cl. 343/702; 343/700 MS

(57) ABSTRACT

There is provided a patch antenna. The patch antenna includes a high dielectric constant substrate having a cavity, a radiator disposed on a portion of one surface of the high dielectric constant substrate corresponding to the cavity, a feeder line disposed on the high dielectric constant substrate and supplying a signal to the radiator, and a ground part disposed on the high dielectric constant substrate.

### CROSS-REFERENCE TO RELATED APPLICATIONS

This application claims the priority of Korean Patent Application No. 10-2009-0086099 filed on Sep. 11, 2009, in the Korean Intellectual Property Office, the disclosure of which is incorporated herein by reference.

### BACKGROUND OF THE INVENTION

1. Field of the Invention

The present invention relates to a patch antenna and a wireless communications module, and more particularly, to a patch antenna capable of improving antenna characteristics and achieving a reduction in the size of an antenna, and a wireless communications module.

2. Description of the Related Art

Recently, wireless communications systems have been developed to achieve a size reduction by integrating a signal creation component with a signal reception/transmission component. In order that several components are integrated so as to constitute a wireless communications system, a multilayer ceramic substrate technology is used as an integration technology.

However, a planar microstrip patch antenna, implemented using a multilayer ceramic substrate, suffers from limitations such as surface waves, narrow bandwidth and low efficiency due to a high dielectric constant of a dielectric body constituting the multilayer ceramic substrate. For this reason, in order to form an antenna in a multilayer ceramic substrate, studies focused on improving antenna characteristics by lowering the dielectric constant of the substrate are being conducted.

On the other hand, there is the need for the substrate to maintain a sufficient level of dielectric constant to form other integrated components. Therefore, research directed towards forming a substrate that can satisfy both antenna characteristics and other component characteristics is ongoing.

### SUMMARY OF THE INVENTION

An aspect of the present invention provides a patch antenna capable of enhancing antenna characteristics and achieving a size reduction, and a wireless communications module.

According to an aspect of the present invention, there is provided a patch antenna including: a high dielectric constant substrate having a cavity; a radiator disposed on a portion of one surface of the high dielectric constant substrate corresponding to the cavity; a feeder line disposed on the high dielectric constant substrate and supplying a signal to the radiator; and a ground part disposed on the high dielectric constant substrate.

The cavity may have an enclosed structure.

The high dielectric constant substrate may be a low temperature co-fired ceramic (LTCC) multilayer substrate.

The feeder line may be formed in the cavity.

The ground part may be disposed on the other surface of the high dielectric constant substrate.

According to another aspect of the present invention, there is provided a wireless communications module including: a low temperature co-fired ceramic (LTCC) multilayer substrate having an enclosed cavity; a radiator disposed on a portion of one surface of the LTCC multilayer substrate corresponding to the cavity; a feeder line disposed on the LTCC multilayer substrate and supplying a signal to the radiator; a ground part disposed on the LTCC multilayer substrate; and at least one electronic device mounted on the LTCC multilayer substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a patch antenna according to an exemplary embodiment of the present invention;

FIG. 2 is a cross-sectional view illustrating a wireless communications module according to another exemplary embodiment of the present invention; and

FIGS. 3A through 3F are cross-sectional views illustrating an example of manufacturing a patch antenna according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

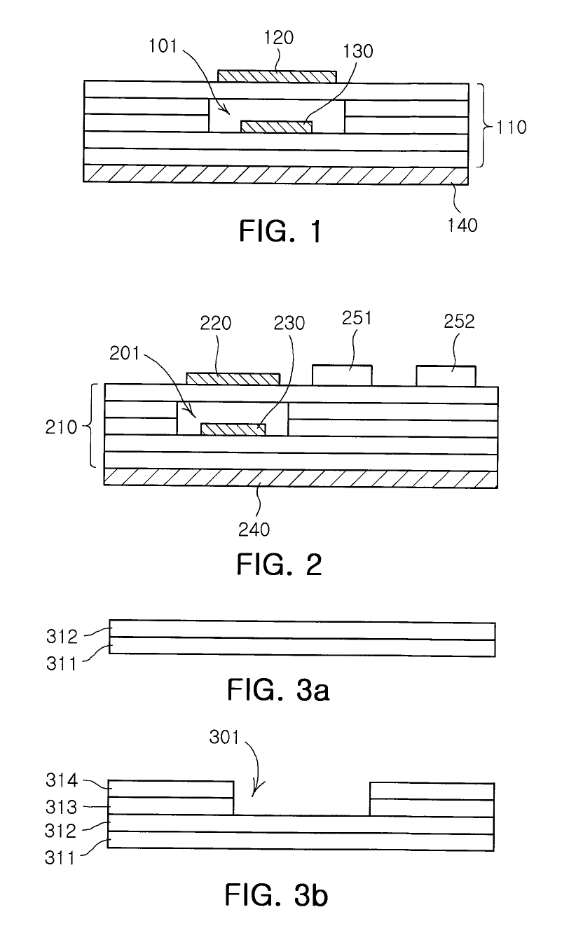

FIG. 1 is a cross-sectional view illustrating a patch antenna according to an exemplary embodiment of the present invention.

Referring to FIG. 1, the patch antenna, according to this embodiment, may include a high dielectric constant substrate 110, a radiator 120, a feeder line 130 and a ground part 140.

The high dielectric constant substrate 110 has a cavity 101 to provide a space in which the radiator 120, the feeder line 130 and the ground part 140 may be formed. According to this embodiment, the high dielectric constant substrate 110 may be a low temperature co-fired ceramic (LTCC) multilayer substrate, and the cavity 101 may have an enclosed structure within the multilayer substrate.

The LTCC multilayer substrate 110 may be formed by stacking a plurality of green sheets and firing a stack of the plurality of green sheets at a low temperature. In order to form the enclosed cavity 101 inside the substrate as in this embodiment, a plurality of green sheets may be stacked, and a green sheet for covering the cavity may then be stacked thereon. According to this embodiment, the dielectric constant of the green sheets for forming the LTCC multilayer substrate may range from approximately 7 to 8.

The radiator 120 may be disposed on one surface of the high dielectric constant substrate 110. Here, the location of the radiator 120 may correspond to the cavity 101. Antenna characteristics may be significantly affected by the dielectric constant of a substrate where a radiator is formed. As in this embodiment, if the LTCC multilayer substrate is used as an antenna board, it may achieve a reduction in antenna size; however, antenna characteristics may be impaired when a radiator is formed on a printed circuit board (PCB) having a low dielectric constant. Therefore, this embodiment provides the cavity 101 inside the LTCC multilayer substrate on which the radiator 120 is formed, thereby lowering the dielectric constant of the entire substrate. Considering that the dielectric constant of air is approximately 1 in general, the dielectric constant in the cavity 101 therefore becomes 1, so that the dielectric constant of the entire LTCC multilayer substrate having the cavity 101 can be lowered as compared to the dielectric constant of an LTCC multilayer substrate without the cavity. Accordingly, the transmission characteristics of the radiator can be improved.

The feeder line 130 may supply a signal to the radiator 120. The feeder line 130 may be connected directly to the radiator 120. However, according to this embodiment, the feeder line 130 may be separated from the radiator 120 at a predetermined interval. The feeder line 130 and the radiator 120, separated from each other at predetermined interval, may be electromagnetically coupled with each other so that a signal can flow in the radiator 120. According to this embodiment, the feeder line 130 may be formed within the cavity 101 in the LTCC multilayer substrate 110.

The radiator 120 is connected to the ground part 140 to send radio waves to the radiator 120. According to this embodiment, the ground part 140 may be formed on the bottom surface of the LTCC multilayer substrate.

As described above, since the patch antenna employs the LTCC multilayer substrate, a reduction in antenna size can be achieved, and the cavity provided inside the LTCC multilayer substrate may contribute to improving the bandwidth and radiation characteristics of the antenna.

FIG. 2 is a cross-sectional view illustrating a wireless communications module according to another exemplary embodiment of the present invention.

Referring to FIG. 2, the wireless communications module, according to this embodiment, may include a high dielectric constant substrate 210, a radiator 220, a feeder line 230, a ground part 240 and electronic devices 251 and 252.

The high dielectric constant substrate 210 has a cavity 210 therein to thereby provide a space where the radiator 220, the feeder line 230 and the ground part 240 may be formed. In this embodiment, the high dielectric constant substrate 210 may be an LTCC multilayer substrate, and the cavity 201 may be enclosed inside the multilayer substrate.

The LTCC multilayer substrate 210 may be formed by stacking a plurality of green sheets and firing a stack of the plurality of green sheets at a low temperature. In order to form the enclosed cavity 201 inside the substrate as in this embodiment, a plurality of green sheets may be stacked, and a green sheet for covering the cavity may then be stacked thereon. According to this embodiment, the dielectric constant of the green sheets for forming the LTCC multilayer substrate may range from approximately 7 to 8.

Circuit patterns, connecting the electronic devices 251 and 252 mounted on the LTCC multilayer substrate 210, may be formed between the stacked surfaces of the stacked green sheets. The circuit patterns may be electrically connected by conductive vias penetrating the stacked green sheets. In the drawing, the detailed illustrations of the circuit patterns and the conductive vias are omitted. Furthermore, an electrode constituting a capacitor may be formed on the stacked surface of the multilayer substrate.

The radiator 220 may be disposed on one surface of the high dielectric constant substrate 210. Here, the location of the radiator 220 may correspond to the cavity 201. Antenna characteristics may be significantly affected by the dielectric constant of a substrate where a radiator is formed. If the LTCC multilayer substrate is used as an antenna board as in this embodiment, it may achieve a reduction in antenna size; however, antenna characteristics may be impaired when the radiator is formed on a printed circuit board (PCB) having a low dielectric constant. Therefore, this embodiment provides the cavity 201 inside the LTCC multilayer substrate on which the radiator 220 is formed, thereby lowering the dielectric constant of the entire substrate. Considering that the dielectric constant of air is approximately 1 in general, the dielectric constant in the cavity 201 therefore becomes 1, so that the dielectric constant of the entire LTCC multilayer substrate having the cavity 201 can be lowered as compared to the dielectric constant of an LTCC multilayer substrate without the cavity. Accordingly, the transmission characteristics of the radiator can be improved.

The feeder line 230 may supply a signal to the radiator 220. The feeder line 230 may be connected directly to the radiator 220. However, according to this embodiment, the feeder line 230 is separated from the radiator 220 at a predetermined interval. The feeder line 230 and the radiator 220, separated from each other at predetermined interval, may be electromagnetically coupled with each other so that a signal can flow in the radiator 220. According to this embodiment, the feeder line 230 may be formed within the cavity 201 in the LTCC multilayer substrate 210.

The radiator 220 is connected to the ground part 240 to send radio waves to the radiator 220. According to this embodiment, the ground part 240 may be formed on the bottom surface of the LTCC multilayer substrate.

The electronic devices 251 and 252 may be mounted on the LTCC multilayer substrate. The electronic devices may be electrically connected by the circuit patterns and the conductive vias formed in the multilayer substrate, and perform desired functions.

As described above, in the wireless communications modules according to this embodiment, a patch antenna is formed using a part of an LTCC multilayer substrate, and electronic devices are mounted on another part of the LTCC multilayer substrate, so that the miniaturization of the wireless communications module can be achieved. This wireless communications module may experience the deterioration in antenna characteristics due to the high dielectric constant of the LTCC multilayer substrate. In order to prevent this deterioration, this embodiment provides the cavity at a location corresponding to that of the radiator. The use of the LTCC multilayer substrate having the cavity can achieve the miniaturization of the LTCC multilayer substrate and enhance the antenna characteristics.

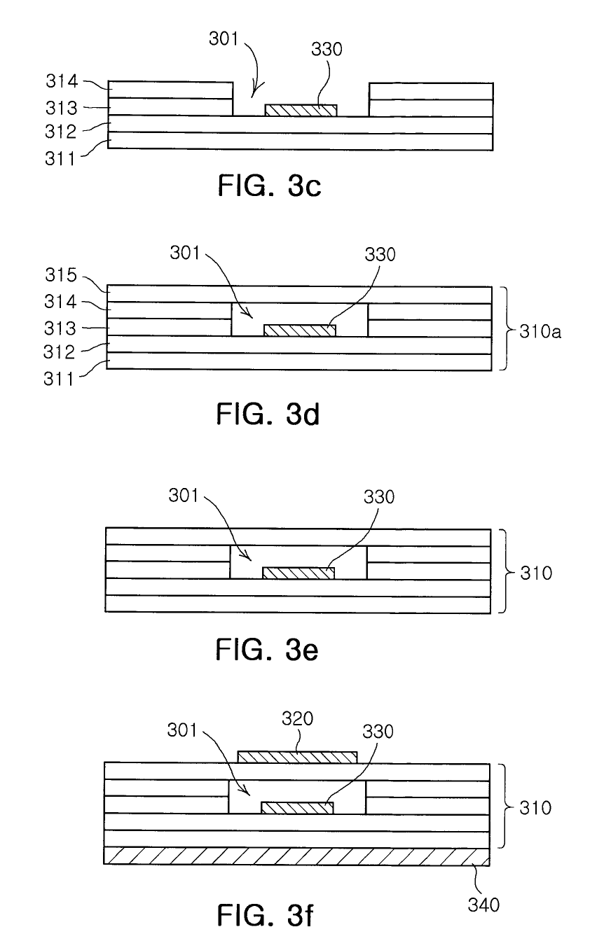

FIGS. 3A through 3F are views illustrating an example of a process of manufacturing a patch antenna according to an exemplary embodiment of the present invention.

FIG. 3A illustrates a process of stacking a first green sheet 311 and a second green sheet 312 in order to form an LTCC multilayer substrate. The first and second green sheets 311 and 322 may be made from a ceramic slurry containing ceramic powder and glass components. After a conductive pattern and a conductive via hole are formed in each of the first and second sheets 311 and 312, the plurality of green sheets may then be stacked. Furthermore, the first green sheet 311 and the second green sheet 312 may be formed using a slurry containing tabular ceramic powder and glass components.

FIG. 3B illustrates a process of stacking a third green sheet 313 and a fourth green sheet 314 in order to form the LTCC multilayer substrate. According to this embodiment, in order to provide an enclosed cavity 301 in the LTCC multilayer substrate, the third and fourth green sheets 313 and 314, before being stacked, may be punched to form a cavity region, and then stacked. Alternatively, the cavity region may be formed by punching the third and fourth green sheets 313 and 314 after stacking the third and fourth green sheets 313 and 134. The third and fourth green sheets 313 and 314 may be produced using a slurry of ceramic powder and glass components.

FIG. 3C is a process of forming a feeder line 330 in the cavity. In this process, the feeder line 330 may be formed by using a printing process. Namely, a feeder line having a desired pattern is printed using conductive paste, and is then dried. According to this embodiment, the feeder line 330, sullying current to a radiator, may be formed in this process in order to place it inside the cavity 301. To place the feeder line 330 at a different location, the order of the actions of the process may be changed. For example, if the feeder line 330 is formed outside the LTCC multilayer substrate, rather than within the cavity region, the process of forming a feeder line may be performed after a process of forming a resultant stack. The feeder line may be formed by a sputtering or deposition process, other than the printing process.

FIG. 3D illustrates a process of stacking a fifth green sheet 315 covering the cavity region. By this process, a stack 310a of the plurality of green sheets may be formed. In this embodiment, five stacked green sheets are illustrated. However, the number of green sheets being stacked may be varied according to electronic devices and circuit patterns formed inside the green sheets, provided that an enclosed cavity is provided inside the stack 310a.

A process of pressing the stack 310a at a constant temperature and under constant pressure may be included. The pressing process may include a first preliminary pressing process and a subsequent second isostatic pressing process. The isostatic pressing process may apply pressure to the stack 310a within water or oil in all directions.

FIG. 3E illustrates a process of firing the stack to form the LTCC multilayer substrate. The stack 310a formed by the process depicted in FIG. 3D may be co-fired at a firing temperature of the stacked green sheets. The firing process may be performed at a low temperature ranging from approximately 800° C. to 1000° C. A jig for firing may be maintained at the top and bottom of the stack. The low temperature firing process may cause the stack 310a of the green sheets to experience horizontal shrinkage and deformation. In order to prevent deformation caused by the firing process, the jigs for firing may be maintained under constant pressure at the uppermost layer and the lowermost layer of the stack 310a. The stack 310a fixed to the jig is prevented from shrinking in the horizontal direction (i.e., X-direction and Y-direction) and shrinks only in a vertical direction (i.e., Z-direction), namely, a thickness direction. The process of co-firing the green sheets with the jigs placed at the upper and lower layers thereof to prevent the green sheets from shrinking in the horizontal direction is called a non-shrinkage process. For the non-shrinkage process, a sheet for high-temperature firing, which is not fired at a low temperature, may be used instead of the jig, and this sheet may be removed after the firing process.

FIG. 3F illustrates a process of forming a radiator and a ground part on the LTCC multilayer substrate. In this process, a radiator 320 and a ground part 340 are printed using conductive paste on the sintered LTCC multilayer substrate 310, and are then dried. The radiator 320 and the ground part 340 may be formed by a sputtering or deposition process, other than the printing process.

As set forth above, according to exemplary embodiments of the invention, the patch antenna and the wireless communications modules can be reduced in size, and the radiation characteristics of the antenna can be improved.

The present invention is not limited to the above embodiments and accompanying drawings. Namely, the thickness of a stack and the components of green sheets may be implemented variously. While the present invention has been shown and described in connection with the exemplary embodiments, it will be apparent to those skilled in the art that modifications and variations can be made without departing from the spirit and scope of the invention as defined by the appended claims.

What is claimed is:

1. A patch antenna comprising:
a high dielectric constant substrate having a cavity;
a radiator disposed on a portion of one surface of the high dielectric constant substrate corresponding to the cavity;
a feeder line disposed on the high dielectric constant substrate and supplying a signal to the radiator; and
a ground part disposed on the high dielectric constant substrate.

2. The patch antenna of claim 1, wherein the cavity has an enclosed structure.

3. The patch antenna of claim 1, wherein the high dielectric constant substrate is a low temperature co-fired ceramic (LTCC) multilayer substrate.

4. The patch antenna of claim 1, wherein the feeder line is formed in the cavity.

5. The patch antenna of claim 1, wherein the ground part is disposed on the other surface of the high dielectric constant substrate.

6. A wireless communications module comprising:
a low temperature co-fired ceramic (LTCC) multilayer substrate having an enclosed cavity;
a radiator disposed on a portion of one surface of the LTCC multilayer substrate corresponding to the cavity;
a feeder line disposed on the LTCC multilayer substrate and supplying a signal to the radiator;
a ground part disposed on the LTCC multilayer substrate; and
at least one electronic device mounted on the LTCC multilayer substrate.

7. The wireless communications module of claim 6, wherein the feeder line is disposed in the cavity.

8. The wireless communications module of claim 6, wherein the ground part is disposed on the other surface of the LTCC substrate.
